(19) United States
(12) Patent Application Publication
(10) Pub. No.: US 2006/0212377 A1
(43) Pub. Date: Sep. 21, 2006

(54) Method and system for analyzing and reporting equity compensation

(75) Inventors: Kathryn Smith, Dublin (IE); Martin Hirsch, Teaneck, NJ (US)

Correspondence Address: PROSKAUER ROSE LLP;PATENT DEPARTMENT, 1585 BROADWAY, NEW YORK, NY, 10036-8299, US

(73) Assignee: UBS AG

(21) Appl. No.: 11/314,932

(22) Filed: Dec. 20, 2005

Related U.S. Application Data
(60) Provisional application No. 60/662,227, filed on Mar. 16, 2005.

(51) Int. Cl. G06Q 99/00; G06Q 40/00

(52) U.S. Cl. 705/35; 705/1

(57) ABSTRACT

Computer systems and methods for reporting and analyzing grants equity-based compensation (e.g., employee stock option grants). The systems and methods store information regarding grants down to each individual grant level. The system and methods are capable of producing reports “as of” particular dates (i.e., transaction dates, creation dates, and accounting date) that are compliant with Financial Accounting Standards Board standards and other accounting standards governing reporting of equity-based compensation without having to manually process large amounts of data.

### CROSS-REFERENCE TO RELATED APPLICATIONS

This application claims the benefit of and incorporates herein by reference U.S. Provisional Application No. 60/662,227, filed Mar. 16, 2005, entitled “Method And System For Analyzing And Reporting Equity Compensation.”

The following applications are related applications and incorporated herein by reference: U.S. Patent Application No. 60/542,504, filed on Feb. 6, 2004, entitled “Methods And Systems For Exercising Stock Options;” U.S. patent application Ser. No. 10/718,883, filed Nov. 20, 2003, entitled “Employee Stock Plan Administration Systems And Methods;” and U.S. patent application Ser. No. 10/003,613, filed Nov. 2, 2001, entitled “System And Method For Implementing Employee Stock Plans,” which is a continuation-in-part of U.S. patent application Ser. No. 09/779,114, filed Feb. 8, 2001, entitled “System And Method For Execution Of Trades Made Pursuant To Stock Option And Purchase Plans,” which in turn claims the benefit of U.S. Provisional Patent Application No. 60/182,399, filed Feb. 14, 2000.

### FIELD OF THE INVENTION

The present invention relates generally to financial reporting of equity or share-based compensation. More particularly, the present invention relates to computer systems and methods which produce reports to enable entities that provide equity-based compensation to comply with standards for accounting for equity-based compensation.

### BACKGROUND OF THE INVENTION

Many entities (e.g., corporations) engage in transactions in which they provide their employees or suppliers with equity or share-based compensation (e.g., stock options). Equity or share-based compensation is an arrangement under which (a) one or more suppliers of goods and services (including employees) receive awards of equity shares, equity share options, or other equity instruments or (b) an entity incurs liabilities to suppliers (1) in amounts based, at least in part, on the price of the entity's shares or other equity instruments or (2) that require or may require settlement by issuance of the entity's shares. Shares include various forms of ownership interest (for example, partnership interests), as well as other interests, including those that are liabilities in substance but not in form.

Examples of different forms of equity-based compensation include employee stock option plans (“ESOP”), employee stock purchase plans (“ESPP”), restricted stock agreement plans (“RSA”). Stock plans provide a variety of benefits for both the employer and employee. Employers, for instance, may benefit with increased tax savings, cash flow, and increased productivity, and employees granted a stake in the companies for which they work are able to share financially in that company's success. An employee stock option is generally a contractual right granted to an employee or employees that gives the employees the option to purchase company stock during a specified period at a predetermined price. An ESPP similarly allows employees to purchase company stock, however, rather than at a predetermined price, the employee usually purchases the stock at a discounted price. Under a restricted stock agreement, the company generally grants company stock to an employee subject to specific vesting and transfer restrictions.

Administering equity-based compensation plans is a complex and burdensome endeavor. Different plans can and do have different qualifications for and limitations on participation. The entities providing those plans are subject to many different regulations and requirements. The burden is compounded for companies conducting business on a national or international scale having a relatively large number of employees that are qualified or able to participate in those plans.

Included among the many different regulations and requirements applicable to equity-based compensation plans are complex accounting and reporting requirements. For example, the Financial Accounting Standards Board (FASB) has issued a series of standards for the reporting of equity or share-based compensation, including financial Accounting Standard (FAS) Nos. 123 (revised), 128, and FASB Interpretation Nos. 28 and 44, which are incorporated herein by reference. The FASB standards include, for example, requirements for reporting an entity's diluted earnings per share. Generally, diluted earnings per share is determined based on the potential dilution to earnings per share from the issuance of potential common shares of an entity's equity, including shares that are issuable upon conversion of convertible debt, convertible preferred stock, or the exercise of employee stock options.

There are prior art computer-based methods and systems for administering equity-based compensation programs, but those prior art methods and systems for administering stock option plans are not capable of providing reports that are in full compliance with FASB and other accounting standards applicable to the reporting of equity compensation. Prior art computer-based systems that are used to administer employee stock option plans, such as Transcentive's Express Options and E-trade's Equity Edge System, are capable of providing a limited set of reports that can assist entities in complying with FASB standards, but those systems are not capable of producing reports that are fully-compliant with FASB standards without requiring additional processing of data generated from those limited reports. Users of current stock option plan administration systems that have limited reporting capability would still have to manually process large amounts of data and/or create multiple computer-based spreadsheets to be able to produce reports that are fully-compliant with FASB standards and other regulations and requirements for accounting for equity-based compensation without requiring additional manual processing.

Prior art systems are also not capable of storing information about grants (i.e., awards of equity-based compensation to employees of equity or equity options) down to each individual's single grant level. Prior art systems aggregate information regarding individual grants in a manner that does not allow the data to be directly accessed on an individual grant basis. To be able to produce reports that are fully compliant with FASB and other accounting standards that govern the reporting of equity-based compensation without additional processing, it is useful and advantageous to be able to access and process data for individual grants for all required reports.

There are three different types of dates associated with grants of equity-based compensation: transaction dates, creation dates, and accounting dates. Transaction dates are the actual dates that transactions occur, e.g., the date that equity-based compensation was granted or the date that the grant of equity-based compensation was exercised. Creation dates are the dates that transactions are entered into computer-based systems for administering, analyzing, and reporting equity-based compensation. Accounting dates are the dates that equity-based compensation transactions should be recognized for accounting purposes. Prior art systems are not capable of storing all three types of dates related to various events regarding grants of equity-based compensation. Storing creation, accounting, and transaction dates separately for each grant of equity-based compensation results in improved reporting capabilities. Being able to access and process data for all three types of dates provides flexible “as of” reporting capabilities that are lacking from prior art systems. “As of” reporting capabilities refer to the ability to produce reports analyzing equity-based compensation “as of” a particular date (i.e., transaction date, creation date, and accounting date). Prior art systems also require historical results to be restated when producing reports.

Different entities that provide equity-based compensation grants may operate based on different fiscal calendars. For some entities, the fiscal year will coincide with the calendar year. For other entities, the fiscal year may not coincide with the calendar year. Prior art systems are not capable of being able to store, process, and analyze, and report data for multiple entities that operate based on different fiscal calendars.

Prior art systems are also incapable of locking down fiscal reporting periods to “close the books” so that data reported for a particular period of time will not change, regardless of transactions loaded after the fiscal reporting period is locked.

### SUMMARY OF THE INVENTION

It is an object of the invention to overcome the deficiencies of the prior art and provide a computer-based method and system for analyzing and reporting equity-based compensation that is capable of producing reports that are fully-compliant with FASB and other accounting standards without requiring additional processing of data.

In one embodiment, the method involves storing in a computer data store information regarding a financial calendar for an entity providing equity-based compensation; information regarding how the entity determines how grants of equity-based compensation are awarded, vested, and forfeited in the data store; information regarding methods that the entity uses to account for equity-based compensation in the data store; transaction information regarding the entity's grants of equity-based compensation; communicating a request to the data store via a client device to use the information stored in the data store to produce financial accounting reports for the entity's grants of equity-based compensation; and receiving requested financial accounting reports produced from information stored in the data store.

In another embodiment, the system involves at least one server computer connected to a computer connected over a communication network to at least one client device, the at least one server computer including application programming; a data store for analyzing and reporting equity-based compensation, the system being operative for: receiving identification information from a user; determining the user's entitlement to available features of the system based on the identification information; sending and receiving requests to the data store via a client device to produce financial accounting reports for the entity's grants of equity-based compensation; producing the financial accounting reports from the data store in response to the requests; and sending the financial accounting reports to the user, wherein the data store is programmed to store and process information including information regarding a financial calendar for an entity providing equity-based compensation; information regarding how the entity determines how grants of equity-based compensation are awarded, vested, and forfeited in the data store; information regarding methods that the entity uses to account for equity-based compensation in the data store; information regarding daily and monthly unit and dollar values for amortizing the expense of each individual grant for each date over the life of the grant; and transaction information regarding the entity's grants of equity-based compensation.

In another embodiment, the information regarding the financial calendar for the entity providing equity-based compensation includes information regarding whether any fiscal reporting periods should be locked.

In another embodiment, the information regarding the methods that the entity uses to account for equity-based compensation includes information regarding methods that the entity uses to determine fair market value of equity-based compensation grants.

In another embodiment, the data store is programmed to store and process the transaction information by individual grant and the data store can access transaction information by individual grant.

In another embodiment, the transaction information includes grant type and grant identification information.

In another embodiment, the system additionally comprises a data extract tool connected to the data store and a second data store for a system for administering equity-based compensation.

In another embodiment, the information regarding methods that the entity uses to account for equity-based compensation includes option pricing model information.

In another embodiment, the data store is programmed to receive and process the requests to produce financial accounting reports that include filters for including information or excluding information from the financial accounting reports.

In another embodiment, the data store is programmed to receive, process, and store information to produce unit and dollar values for the total expense of an individual grant that reflects the impact of actual forfeitures or estimated (estimated grant level turnover percentage) forfeitures at any point in time over the life of the grant.

In other embodiments, the financial accounting reports produced comply with FASB accounting standards without the need for additional data processing. The financial accounting reports produced include an Option Roll Forward Report, Options Outstanding Report, Options Expense Report, Actual Forfeiture Report, FAS Disclosure Summary Report, Assumption Detail and Averages Report, and Earnings Per Share Report.

In other embodiments, the transaction information includes information regarding exercised options, canceled options, forfeited options, option prices, and transaction dates, and the data store is programmed to store creation dates and accounting dates.

The invention has other advantages over prior art systems that do not include the capability of storing information about equity compensation grants down to the individual grant level. Existing systems aggregate information regarding equity compensation grants in a manner that does not allow the data to be accessed on an individual grant basis.

The invention is also capable of storing all date information related to various events regarding stock option grants. This results in improved reporting capabilities.

The method and system of the invention operate based on a financial calendar system that allows each individual entity that uses each entity's particular financial calendar. For example, different entities may operate based on different fiscal calendars. For some entities, the fiscal year will coincide with the calendar year. For other entities, the fiscal year may not coincide with the calendar year. The invention has the capability of being able to store and process data for multiple entities that operate based on different fiscal calendars.

The invention also enables users to lock down fiscal reporting periods to “close the books” so that data reported for the periods will not change regardless of transactions loaded after the fiscal reporting period is locked.

As an aspect of the present invention, a computer may perform some or all of the steps in the inventive method.

These objects and advantages of the invention described above are illustrative and not exhaustive. The foregoing advantages and other advantages will become more apparent from the accompanying drawings and following detailed description.

### BRIEF DESCRIPTION OF THE FIGURES

FIG. 1 is a block diagram of a computer system for providing centralized employee stock plan administration according to one embodiment of the invention;

FIG. 2 is a block diagram of the application architecture for a computer system providing centralized employee stock plan administration according to one embodiment of the invention;

FIG. 3 is flow diagram of a method for analyzing and reporting equity-based compensation according to one embodiment of the invention;

FIGS. 4, 5, 6, 7, 8, 9, 10, 11A, 11B, and 11C are screen diagrams of user interfaces for analyzing and reporting equity-based compensation according to one embodiment of the invention;

FIG. 12 is flow diagram of for extracting data from a data store for an existing equity-based compensation administration system to be used in a data store according to one embodiment of the invention.

FIGS. 13 and 14 are screen diagrams of user interfaces for analyzing and reporting equity-based compensation according to one embodiment of the invention;

FIGS. 15-21 are examples of screen diagrams of financial reports produced according to an embodiment of the invention.

### DETAILED DESCRIPTION OF THE INVENTION

Typically, there are specialists that handle the administration of equity-based compensation plans for the entities that provide them. The specialists can be employees of the entity or outside specialists that provide equity-based compensation administration on a contractual basis. Administering equity-based compensation can include tracking and handling transactions, maintaining records, analyzing data, and generating reports. These functions have typically been accomplished using a combination of manual and automated steps, and also using a plurality of securities trading and/or administration platforms. U.S. patent application Ser. No. 10/718,883, filed Nov. 20, 2003, entitled “Employee Stock Plan Administration Systems And Methods,” describes systems and methods for providing centralized employee stock administration. Centralized equity-based compensation administration generally refers to systems and corresponding methods which provide users with key business functions and data on a single platform thereby providing an effective and efficient way for users to administer and manage employee stock plans. A business function generally relates to an activity performed in the course of administering equity-based compensation.

The present invention can be used with and incorporated into both centralized equity-based compensation administration systems and equity-based compensation administration systems that use a plurality of trading and/or administration platforms. In one embodiment of the present invention, the present invention is integrated into a system for centralized equity-based administration functionality, as described herein, with a client interface communicatively connected to a stock plan administration system, which may be managed for the entity providing equity-based compensation by an outside financial services firm.

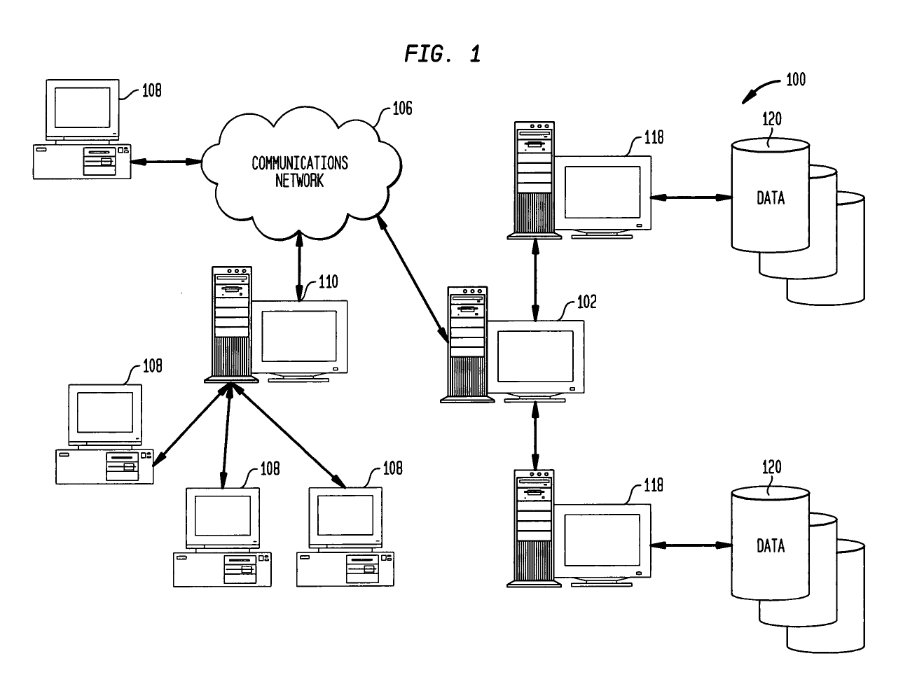

Referring to FIG. 1, a system for providing centralized equity-based compensation administration 100 may include at least one client device 108 connected over a communication network 106 to at least one server computer, such as proxy server 102 and/or a web/application server or servers 118, having at least one database 120 associated therewith. The communications network 106 is any suitable communications link, such as a local area network (LAN), wide area network (WAN), the Internet, etc., a wireless network, or any combinations thereof. The client devices 108 may also be connected to the server computers 102, 118 via a proxy server 110. A client device is generally a multipurpose computer having a processor and memory that is capable of communicating with the server computers 102, 118 and also capable of displaying information received from the server computers 102, 118. Client devices may be, for example, personal computers (PC), special purpose computers, workstations, wireless devices, such as personal digital assistants (PDA), cellular phones, two-way pagers, or any other devices that are capable of communicating with and receiving information from server computers 102, 118.

In one embodiment, the web/application server 118 includes application programming logic that provides the backend functionality of the invention. The server computers 102, 118 include at least one program application or program module for displaying or causing to be displayed, on a client device 108, an administrator's dashboard interface screen including therein an administrator's dashboard that provides features and metrics associated with at least one employee stock plan relevant to the user logged on to the platform. A dashboard is a user interface that organizes and presents relevant information, such as employee stock plan data, in a way that is easy to view. This aspect of the invention allows users to get key information, e.g., numerical data, relevant to their daily duties, such as alerts, processing statistics, plan activity, plan statistics, contacts, market view, etc., without having to search through various platforms, applications, or interface screens. In one embodiment, the administrator dashboard screen is a homepage or a first page displayed to a user, after logging on to the system, which includes stock plan administration statistics relevant to the user for the previous (yesterday), the current (today), and the following day (tomorrow). In another embodiment, the server computers 102, 118 include at least one application or module that provides navigation and access to a plurality of interface screens and underlying applications consistently throughout the interface screens of the platform. Preferably, the server computer 102, 118 includes applications or modules that provide users with key business functions, including an administrator's dashboard, participant inquiry, workflow, site administration, file exchange, client profile, and events calendar, as well as reporting using the systems and methods of the present invention.

The client devices 108 preferably include programming therein, such as an Internet or Web browser application, for displaying a plurality of graphic user interface screens and for allowing users to communicate requests and data to the stock plan administration system, particularly to the server computers 102, 118. The server computers 102, 118 are associated with one or more databases 120 populated with information relevant for administering employee stock plans, including information pertaining to participants, stock plans, stock prices, etc.

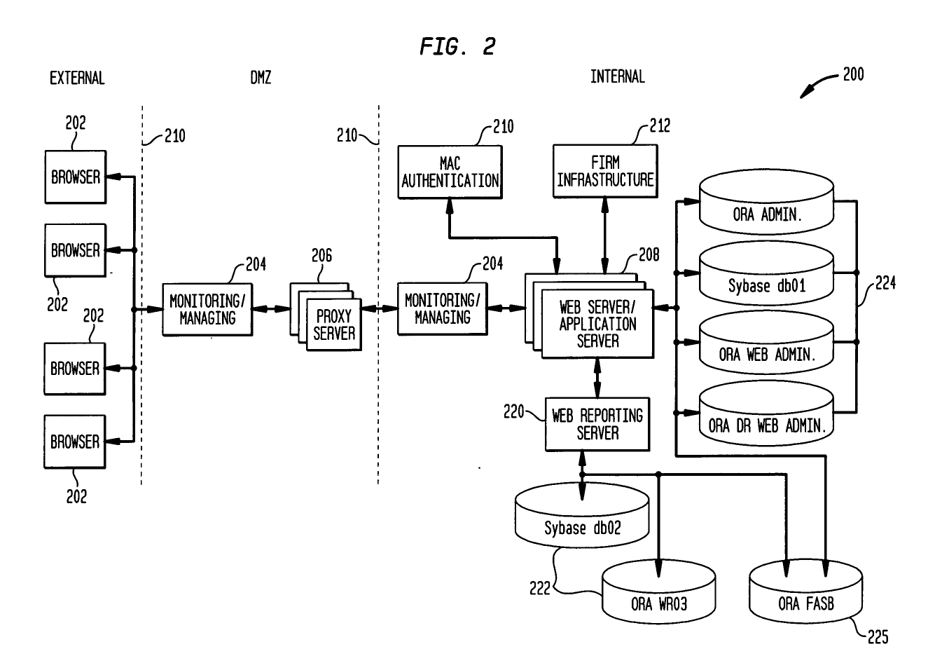

Referring to FIG. 2, in one embodiment, an application architecture for a system which provides centralized equity-based compensation administration may generally be broken down into three categories of applications: external applications, applications in the demilitarized zone (“DMZ”), and internal applications. External applications are generally browser applications 202, such as an Internet or Web browser application, that allow users to communicate requests and data to the stock plan administration system and for displaying interface screens. The applications in the demilitarized zone include proxy server applications 206 and/or network monitoring/managing applications 204. The DMZ generally refers to a sub-network that may sit between firewalls 226, as shown, or off one leg of a firewall. Internal applications, may include network monitoring/managing applications 204, MAC address authentication applications 210, financial service firm infrastructure 212, at least one server application, such as a content manager server 216, a web reporting server 220, a web server, and/or application server 208, and a plurality of data stores 222 and 224 for the centralized equity-based compensation administration system 200 associated with the respective server applications.

In one embodiment, included with the data stores 222 and 224 for the centralized equity-based compensation administration system 200, is a separate data store 225, which is used for processing, storing, calculating, and reporting equity-based compensation according to the present invention. Alternatively, the functionality and capabilities of data store 225 could be included within the functionality and capability of data stores 222 and 224. The embodiment described below, in which there is a separate data store 225, which is used for processing, storing, calculating, and reporting equity-based compensation, provides the advantages of being able to be integrated into an already existing centralized equity-based compensation administration systems, as well as equity-based compensation administration systems that use a plurality of trading and/or administration platforms without having to modify the software of those existing systems as extensively.

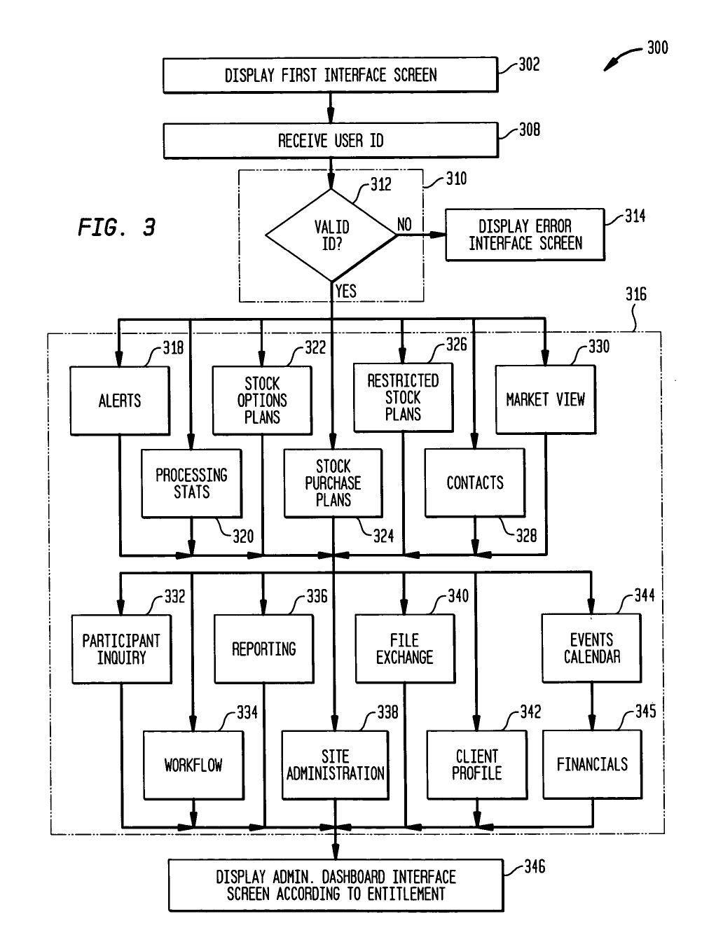

Referring to FIG. 3, a method for analyzing and reporting equity-based compensation 300 begins at step 302 with displaying or causing to be displayed a first interface screen at the client device 108. The first interface screen may be, for instance, the financial service firm's home page, a login page, etc., which is displayed in response to a user request, such as by clicking an icon, hyperlink, etc. with a computer input device, such as a mouse, track ball, touch pad, keyboard, etc. and/or by specifying an Internet protocol (IP) or web address associated with the financial service firm. The first interface screen preferably includes therein navigation elements, such as hyperlinks, action buttons, clickable images, etc., which allow users to navigate to other interface screens. In one embodiment, the first interface screen, includes therein form elements, such as input fields, which allow users to communicate information identifying the user, such as a user ID and password.

If the system receives a request from an appropriate IP address, it receives identification information from the user, step 308, and proceeds to authenticate the identification information, e.g., the user ID and password, step 310. Authentication generally denotes verifying the identity of the user that is attempting to access the system. It is understood that authentication may be accomplished in a variety of ways. In one embodiment, authentication includes comparing the identification information communicated by the user with identification information for a plurality of authorized users stored in one of the databases 120 and/or data stores 224, step 312. If authentication fails, the system displays or causes to be displayed an error interface screen indicating the failed login attempt, step 314. The error interface screen may also include form elements therein which allow users to reattempt login. In one embodiment, the number of login attempts will be limited to a predefined number, such as 3, 4, 5, etc. In the event the predefined number of login attempts have been exhausted, the error interface screen is displayed without the form elements therein.

If at step 312 authentication is satisfied, in one embodiment, the system determines the user's entitlements to available features, step 316. The system, for instance, may determine whether the user is entitled to the relevant metrics provided via an administrator's dashboard interface screen, such as entitlement to alerts 318, processing statistics 320, plan activity and plan statistics for ESOP 322, ESPP 324, and RSA 326 plans, contacts 328, e.g., contact information, and market view 330, e.g., market information. In one embodiment, all users are entitled to the market view feature. The system may also determine entitlement to key business functions, such as entitlement to participant inquiry 332, workflow 334, reporting 336, site administration 338, file exchange 340, client profile 342, events calendar 344, and financials 345. For users that manage or administer stock plans for a plurality of companies, the level or degree of entitlement may be company specific. For instance, the user may be entitled to view plan activity and processing statistics for company A while only being entitled to plan activity for company B. Entitlement may be determined by accessing an entitlement database that includes data regarding entitlements to particular features, metrics, functions, etc. for particular users. The system may also determine row and column entitlement. With regard to row entitlement, the system generally determines and limits access to data for particular participant, and with regard to column entitlement, the system determines and limits access to particular types of data, such as confidential or sensitive participant information. Participant data and/or particular types of data may be filtered and thereby not presented to the user based on one of a plurality of filter criteria, such as country, location, subsidiary, name, address, phone, email address, officer description, officer code, date of birth, social security number, salary, account number or officer class. The administrator's dashboard interface screen may then be displayed or caused to be displayed according to the user's entitlements regarding employee stock plans of a first company, step 346.

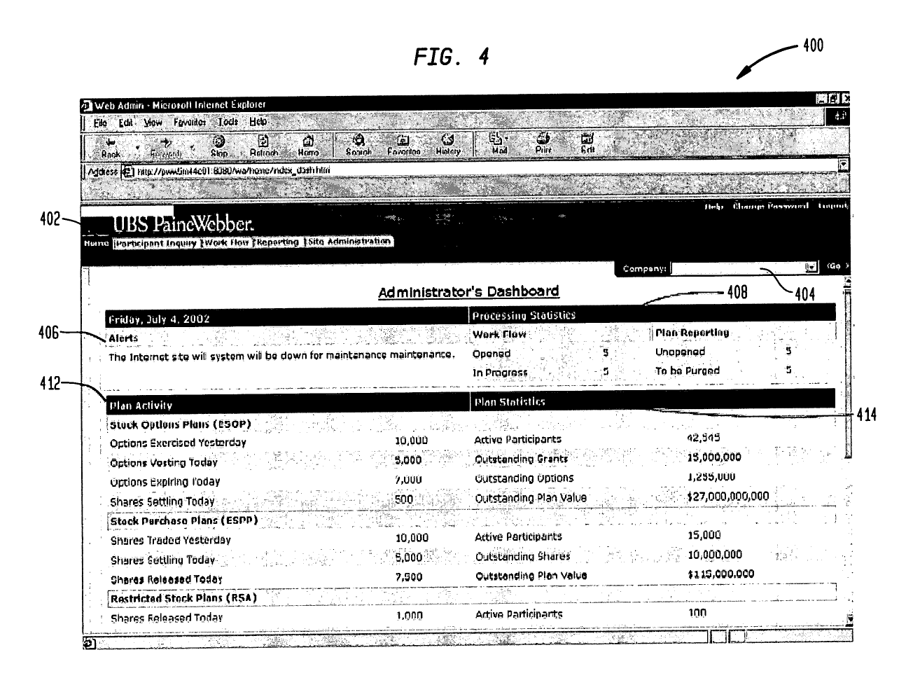

FIG. 4 depicts one embodiment of a graphical user interface for centralized equity-based compensation administration system that incorporates an embodiment of the method and system for analyzing and reporting equity-based compensation of the present invention. Interface screen 400, includes an administrator's interface including relevant metrics and features for the user logged on to the system, such as alerts 406, processing statistics 408, plan activity 412, plan statistics 414. Data displayed under the processing statistics heading generally provides a measure of the progress for workflow and plan reporting requests, which may include processing statistics for one or more companies. Data provided under the plan activity and plan statistics headings provide relevant metrics for particular employee stock option plans that the user is entitled to view. Plan activity metrics may include data regarding the number of shares of company stock exercised, vested, expired, settled, released, etc. for a particular time frame, such as for the day or for the previous day as shown. The particular time frame may be one or more days, weeks, months, etc. In one embodiment, the administrator dashboard screen includes plan activity statistics, relevant to the user, for the previous (yesterday), the current (today), and the following day (tomorrow). Plan statistics metrics may include numerical data regarding the number of active participants, outstanding grants, outstanding options, outstanding plan value, outstanding shares, total elections, etc. The administrator's dashboard interface screen may also include a company form element 404, such as a drop down list, which allows users that manage or administer stock plans for a plurality of companies to switch and correspondingly have an administrator's dashboard screen displayed according to entitlements regarding employee stock plans of another company.

The administrator's dashboard interface screen includes key business function navigation elements 402 therein allowing users to access key business functions, such as an administrator's dashboard, participant inquiry, workflow, reporting, site administration, file exchange, client profile, events calendar, etc., and allowing the user to access the particular key business function interface screen associated therewith in accordance with the user's entitlements. Each key business function navigation element is preferably displayed on the administrator's dashboard interface screen 400 as an individual tab with at least one tab highlighted to indicate which of the available interface screens is being displayed. For instance, when the administrator's dashboard is being displayed, the home tab may be highlighted. The key business function navigation elements, according to one embodiment, are displayed consistently within each of the key business function interface screens. Thus, the user gains access to the key business functions by selecting or clicking a key business function navigation element which results in a navigation request communicated to the system and the system displaying or causing to be displayed a corresponding interface screen, such as an administrator's dashboard interface screen, a participant inquiry interface screen, a workflow interface screen, a reporting interface screen, a site administration interface screen, a file exchange interface screen, a client profile interface screen, or an events calendar interface screen, each including therein key business function navigation elements.

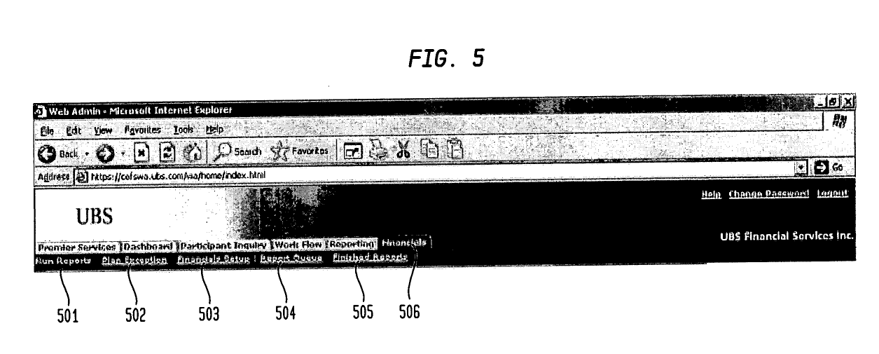

FIG. 5 depicts one embodiment of a user interface that appears when the user selects or clicks the financials tab 506 to access the functionality for analyzing and reporting equity-based compensation. As shown in FIG. 5, there are links 500 that correspond to sub-functions contained within the financials tab 506. Link 501 corresponds to the function run reports, link 502 corresponds to the plan exception function, link 503 corresponds to the financials setup function, link 504 corresponds to the report queue function, and link 505 corresponds to the finished reports function.

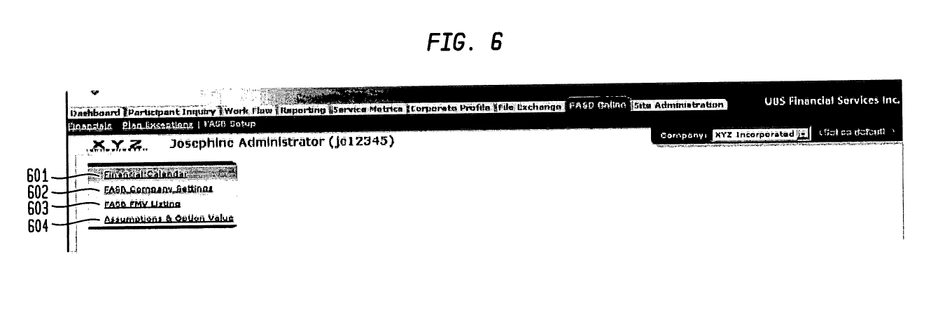

FIG. 6 depicts one embodiment of a user interface that appears when the user selects the financials setup link 503. There four sub-functions within the financials setup function: financial calendar 601, company settings 602, FMV (fair market value) listing 603, and assumptions and option value 604, each of which are discussed below. These functions permit a user to enter default settings about the entity providing equity-based compensation to enable the entity's equity-based compensation to be analyzed and reported. These default settings include settings regarding the entity providing the equity-based compensation and the methods, rules, and assumptions that the entity uses to grant and account for grants of equity-based compensation. These default settings include the entity's financial calendar, methods for calculating FMV, corporate tax rate, methods and rules for expensing grants of equity-based compensation, grant fair values, estimated forfeitures, and assumption values for performing accounting calculations. These settings are stored in data store 225.

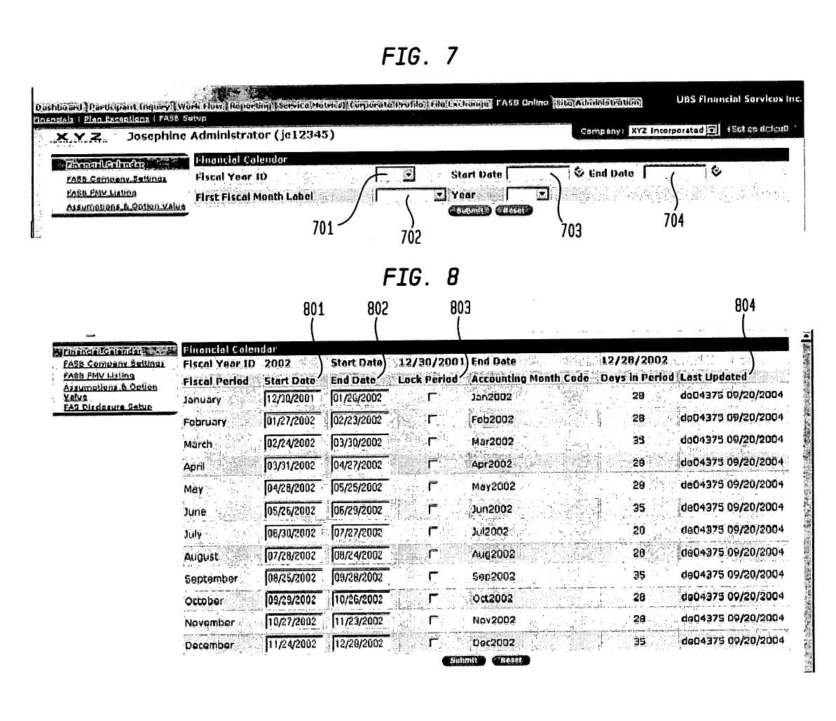

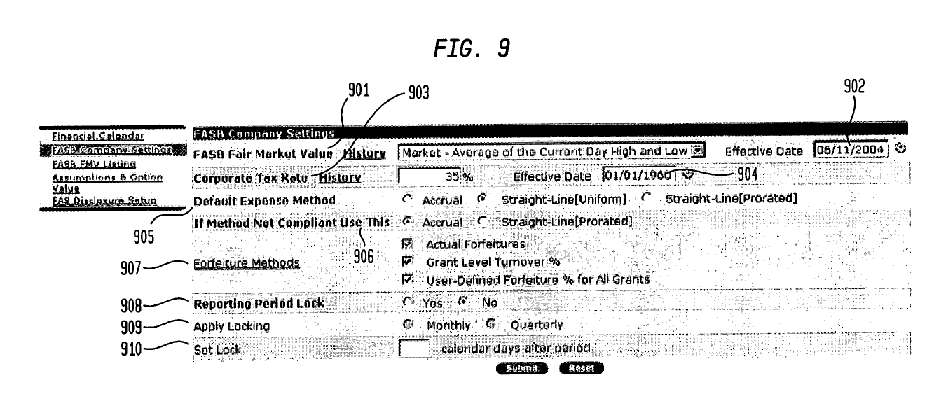

FIGS. 7 and 8 depict embodiments of a user interface screen that appears when the financial calendar sub-function 601 is selected. The financial calendar sub-function 601 allows a user to define the financial reporting period for the entity. Entities can choose their own reporting periods. Each period has a start date and an end date, which preferably correspond to the entity's financial reporting period. Referring to FIG. 7, the user can select a fiscal year ID 701 and the first fiscal month 702, and start 703 and end 704 dates for the fiscal period. The start 703 and end 704 dates can be can be automatically generated or they can be entered manually.

FIG. 8 depicts start dates 801 and end dates 802 for each month of the fiscal year 2002. As shown in FIG. 8, the financial calendar also contains a lock period 803 feature. A fiscal period cannot be modified if the period is locked. When a fiscal period is locked, no new transactions or modifications to existing transactions will be accepted for that fiscal period. Entering a check in a box under lock period 803 indicates that the fiscal period corresponding to the checked box should be locked. The absence of a check indicates that the period should not be locked. The ability of a user to access and use the lock period 803 feature can be made dependent upon the user having correct security privileges. The last updated by column 804 can be used to identify the person who made the last modification to each fiscal period and the date on which that last modification was made.

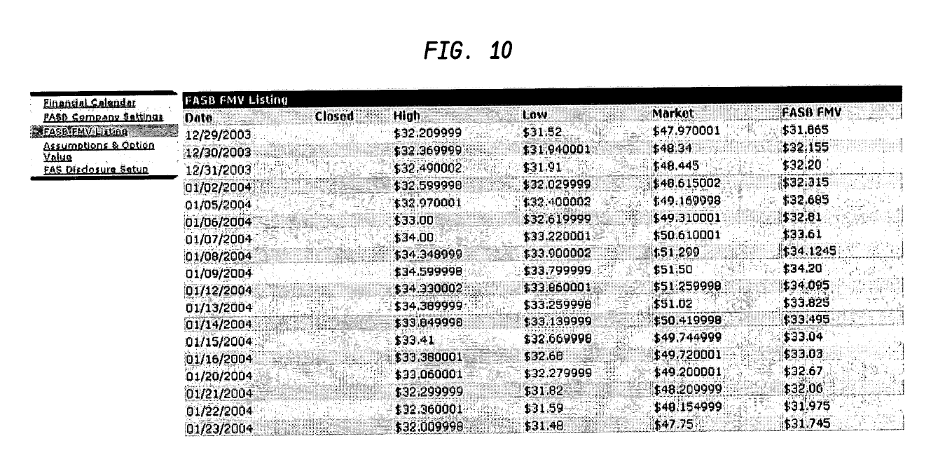

FIG. 9 depicts an embodiment of the user interface screen that appears when a user selects the company settings 602 sub-function. The company settings 602 sub-function allows the user to establish default settings that are used for analyzing and reporting equity-based compensation. Those settings can include FASB Fair Market Value 901, Effective Date 902, Corporate Tax Rate 903, Effective Date 904, Default Expense Method 905, If Method Not Compliant Use This 906, Forfeiture Methods 907, Reporting Period Lock 908, Apply Locking 909, Set Lock 910.

FASB Fair Market Value 901 allows the user to specify a method to be used to calculate the fair market value of equity options that entity has provided. The method that the user selects is, in turn, also used to produce financial reports, such as an earnings per share report for the entity. An entity can select methods for calculating fair market value that include: the current day close (i.e., the current day closing price of the stock of the entity); the average of the current day high price and low price for the stock of the entity, or a user defined method (which, for example, allows the user to enter in its own Fair Market Value for each business day derived outside the system). If a user changes the method for calculating FASB Fair Market Value 901 at a later date, a user can use the Effective Date 902 setting to specify that the new method for calculating FASB Fair Market Value 901 will apply for dates beginning with the Effective Date 902 specified.

The Corporate Tax Rate 903 setting enables a user to select the corporate tax rate for the entity providing equity-based compensation. That Corporate Tax Rate 903 is also used for purposes of analyzing and reporting equity-based compensation. The user can also specify an Effective Date 904 for any changes to the Corporate Tax Rate 903 to specify the date the beginning date for a particular Corporate Tax Rate 903. In analyzing and reporting equity compensation, data store 225 checks the date of each individual grant of equity-based compensation for the entity to determine which corporate tax rate to apply.

The Default Expense Method 905 setting allows the user to select a default method for the entity to use to amortize or accrue the expense for each grant over the life of the grant for financial reporting. The user can select from one of the following methods, including the accrual method (in which a greater percentage of the total expense to be recognized in the earlier periods of the grant of equity-based compensation), the straight line prorated method (in which the expense for each vesting increment or tranche of equity-based compensation is calculated separately), and the uniform method (in which the expense for all vesting increments or tranches is totaled and the expense is spread evenly over the life of the grant of equity-based compensation). The default method selected to calculate the amortization of the expense for the grant may be overridden when valuing each grant if required.

Under the current version of FASB 123R, the compensation cost (expense) recognized at any date, must at a minimum, be equal to the value of the vested portion of the grant. As a result, the uniform method of expense can generate an amortization schedule that does not comply with FASB 123R if the grant does not vest evenly. In that event, the system will assign the alternative method of amortization selected by the user. The If Method Not Compliant Use This 906 setting is used to select which of the accrual or the straight line prorated method is to be used when the uniform method is not compliant for a grant or grants.

The Forfeiture Methods 907 setting enables the user to select one or more methods to be used for calculating forfeitures of awards of equity-based compensation. The actual forfeiture method selection is mandatory and, in addition, a user can select the grant level turnover percentage method, or a user defined percentage. The actual forfeitures method totals all option grants forfeited as of the date the forfeiture event actually occurs. The grant level turnover percentage method uses an annual turnover percentage, which the number of options that will be forfeited per grant each year. The turnover percentage is applied to estimate the reduced number of shares that should be expensed for a grant. The user also can define a straight (hair-cut) annual percentage, which is entered as required when running the options expense report.

The Reporting Period Lock 908, Apply Locking 909, Set Lock 910 settings allow the user to lock fiscal reporting periods. Locking fiscal periods in effect “closes the books” for the fiscal period that is locked and ensures that the data will not be changed. Reporting Period Lock 908 enables the user to select whether reporting periods will be automatically locked (Yes) or not (No). The Apply Locking 909 setting enables the user to select whether the reporting period will be locked automatically by the system monthly or quarterly. The Set Lock 910 setting enables the user to specify the date to initiate the lock for the selected period. For example, if the selected period for the lock is one month, the user could specify that the locking period be set within 5 days of the end of the month. Alternatively, a user can lock a period when needed.

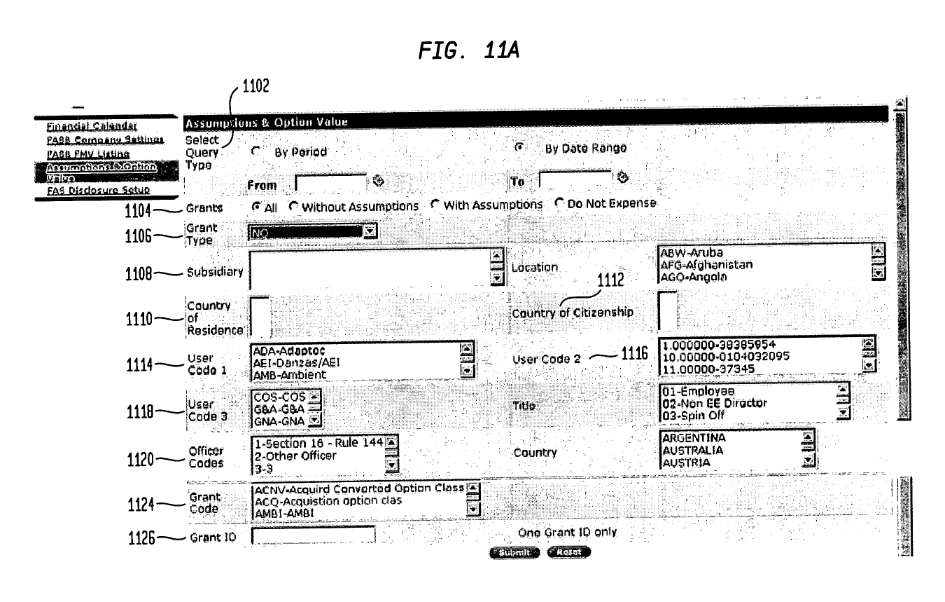

When price information is loaded into data store 225, then a user can view fair market values for a period of time by month or by date range by selecting the FMV (fair market value) listing 603 sub-function. An example of an embodiment of the user interface screen that appear when the user selects the FMV (fair market value) listing 603 sub-function is depicted in FIG. 10, which shows the FASB FMV from Dec. 29, 2004 through Jan. 23, 2004.

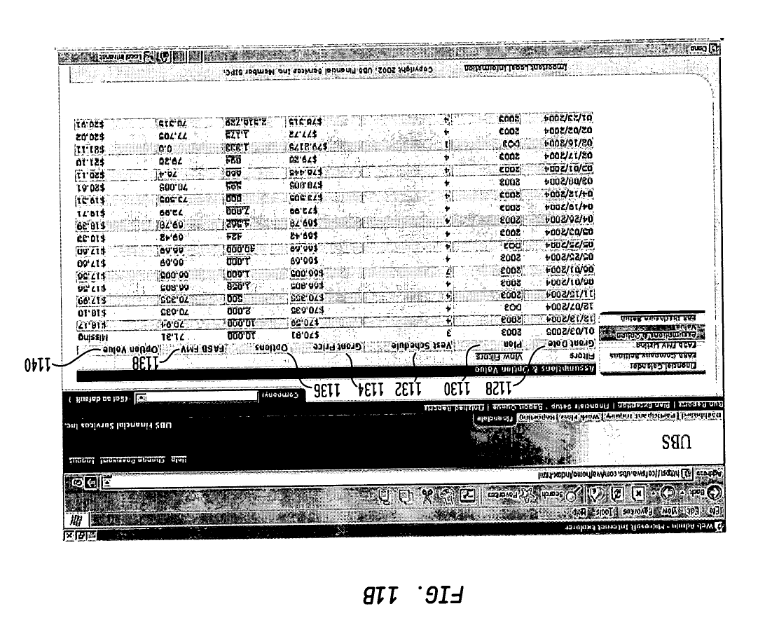

FIGS. 11A, 11B, and 11C depict embodiments of the user interface screens that appear when a user selects the assumptions and option value 604 sub-function. In order to expense a grant of equity-based compensation, the grant must be assigned a set of assumptions and an option value, including the amortization methods and pricing models to be used. If an entity does not want to expense a grant of equity-based compensation, it can choose to flag the grant as a “Do Not Expense Grant” and then the user will not be required to assign a set of assumptions and an option value.

Referring to FIG. 11A, the Select Query Type setting 1102, enables the user to filter grants by period or date range. The Grants setting 1104 enables the user to choose to review grants with assumptions (grants that have assumptions stored), without assumptions (grants that do not have assumptions stored), Do Not Expense grants that were flagged as grants not to be expensed, and all grants. The user also can filter and review grants by grant type 1106, subsidiary of the entity providing grants 1108, country of residence 1110 and citizenship 1112 of the grantee, by user codes 1114, 1116, and 1118, officer codes 1120, country 1122, grant code 1124, and grant ID 1126 (identification number assigned to grant).

Referring to FIG. 11B, information regarding the grant date 1128 (the date that equity-based compensation was granted), the plan 1130 from which the grants were issued, the vesting schedule 1132 (by identification number assigned to a particular vesting schedule) assigned to the grant, the grant price 1134, the number of options 1136, the FASB FMV 1138 for each grant on the date of the grant, and the current option value 1140.

Referring to FIG. 11C, the user can select whether to expense a grant or not using the expense grant setting 1140. The user can select the option pricing model 1142 used to derive the values of the grants of equity-based compensation. For example, the user could select the Black-Scholes option pricing model, the binomial model, or any other model that could be used to derive the values of grants of equity-based compensation. The user can select the amortization method 1144 to be used (e.g., accrual, straight-line (uniform), or straight-line (prorated).) The user also can select the valuation method 1146, which determines if one or more assumptions are assigned to each grant. If the method is single, only one set of assumptions is entered. Thus, one option value will exist for all options of the grant, regardless of the vesting date of the grant. If the multiple method is selected, then the user can enter different assumption sets for particular grants and a start and end date for each set of assumptions in columns 1148 and 1150. An assumption set comprises the volatility rate, risk free rate 1152, dividend percentage, option prices (not required to be entered), and the fair market value on date of grant (also not required to be entered as this data is already stored in the price table). A user may also enter the turnover percentage at this time for calculating estimated forfeitures or use the function to enter or modify grant level turnover percentage only.

In embodiments where there are existing data stores of an equity-based compensation administration system, data from the administration system can be extracted from and imported into a data store for processing, storing, calculating, and reporting equity-based compensation. In these embodiments, extracting data from existing data stores of an existing equity-based compensation administration system provides the advantage of being able to integrate the data store for processing, storing, calculating, and reporting equity-based compensation without having to rewrite all of the software code for the existing administration system.

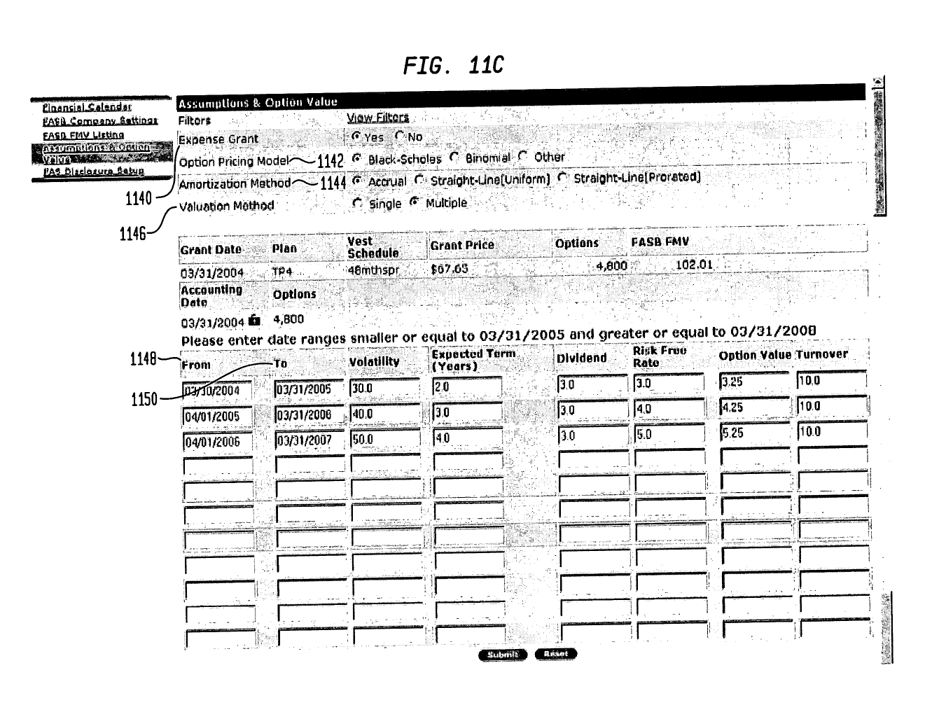

FIG. 12 is flow diagram for extracting data from a data store for an existing equity-based compensation administration system to be used in a data store according to one embodiment of the invention. As shown in FIG. 12, a data extract tool 1204 extracts data from a data store 1202 for an existing equity-based compensation administration system, such as data stores 222 and 224 for the centralized equity-based compensation administration system 200 of FIG. 2. The data extract tool 1204 sends the extracted data to a temp area 1206, where the data is compared with data extracted from data store 1202 from the last time that data was extracted to determine what data was entered into modified, or deleted from data store 1202 since the last time that data was extracted. The data extract tool could be run at the end of every day or any other convenient time interval. After the data extract tool ascertains what data was entered into data store 1202 since the last time that data was extracted, that new data is transferred to a data store for processing, storing, calculating, and reporting equity-based compensation 1208, such as data store 225 of FIG. 2.

Information in data store 225 is stored and is capable of being accessed and processed by individual grant of equity-based compensation. In addition to the settings regarding the entity providing the equity-based compensation, the entity's financial calendar, methods for calculating FMV, corporate tax rate, expense methods, and rules, and assumption values for performing calculations, data store 225 also contains additional information. The information, which data store 225 stores and can access on an individual grant basis, is information that enables data store 225 to analyze equity-based compensation and to produce reports, including reports that help clients comply with FASB standards without requiring additional calculations or processing. Those reports, which are described below, include the Option Roll Forward Report, Options Outstanding Report, Options Expense Report, Actual Forfeiture Report, FAS Disclosure Summary, Assumption Detail and Averages Report, and EPS Report, and Deferred Tax asset Reports. Data store 225 also could be adapted to provide capability to produce additional reports should accounting standards, including the FASB standards described above, be changed to require different or additional reports than the currently required reports.

The information contained in data store 225 includes data regarding the person who has been provided equity-based compensation, including the person's name, identification number and contact information, the entity that has provided the person with equity-based compensation, the person's location, title and position, hire date, termination date, and reasons for termination. Data store 225 includes three different types of dates associated with grants of equity-based compensation: transaction dates, creation dates, and accounting dates. Data store 225 includes all grant details, including the vesting schedules, identification of the plans pursuant to which the grants were made, and changes in grants. Data store 225 includes all exercise information, including grant dates, exercised options, prices, taxable compensation, and exercise type. Data store 225 includes detailed information regarding cancelled grants. It also includes details regarding any splits in the granting entity's equity and the prices at which the granting entity's equity have traded, including the daily high, low, and closing prices for the granting entity's equity.

Data store 225 also stores the state of amortization schedule for each grant with a daily and monthly amount in units and dollars for each date range. In the event that changes are made to a grant, data store 225 stores a new amortization schedule for the date on which the change to the grant occurs, while also preserving all old amortization schedules. This facilitates true “as of” reporting.

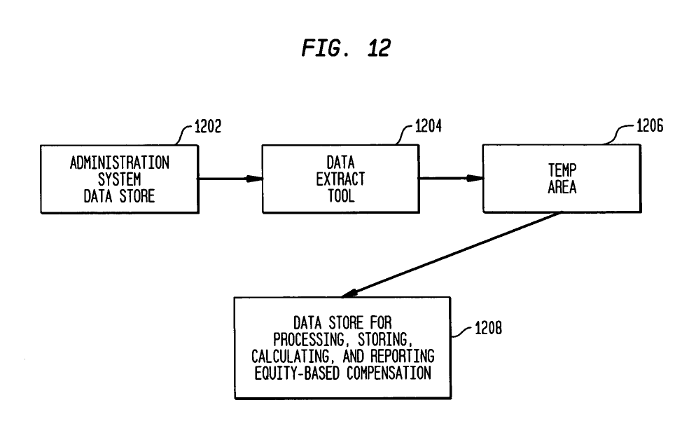

To create a report, a user clicks on link 501 of FIG. 5, which corresponds to the run reports function. The user then selects from one of the links shown in FIG. 13 to create a report corresponding to the link: Option Roll Forward Report 1301, Options Outstanding Report 1302, Options Expense Report 1303, Actual Forfeiture Report 1304, FAS Disclosure Summary 1305, Assumption Detail and Averages Report 1306, and EPS Report 1307. These reports, which an entity that provides equity-based compensation must be able to are described generally below. The specifics of what is required to be presented in these reports are described in further detail in including Financial Accounting Standard (FAS) Nos. 123 (revised), 128, and FASB Interpretation Nos. 28 and 44, which are incorporated herein by reference. Persons of ordinary skill in the art also could adapt data store 225 to produce reports other than those depicted in FIG. 13 to use data store 225 to comply with future changes in financial accounting standards for reporting equity-based compensation.

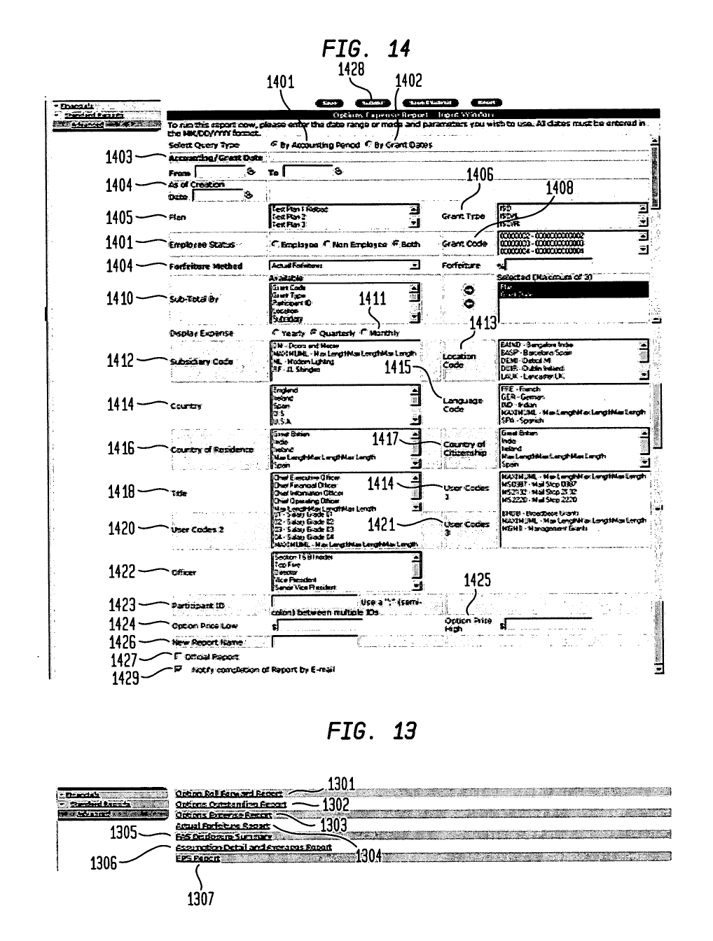

Data store 225 also has the capability to filter data to allow users include or exclude certain information in a report to enable users to analyze and report equity-based compensation data more efficiently. After the user selects the type of report to be produced, the user then selects the filters that the user wants to include in the report and inputs information into those filters via a user interface screen. FIG. 14 is an embodiment of a user interface screen that shows examples of the filters that can be made available to a user. Filters can be used individually or in combination to analyze and report data by accounting period 1401, by grant dates 1402, by accounting grant date from a period beginning on one date and ending on another date 1403, by as of a specified creation date 1404, by plan 1405, by grant type 1406, by employee status 1407, by grant code 1408, or by forfeiture method 1409. Results may be subtotaled data by various data attributes 1410, including for example, grant code or grant type. The user may also specify how the user wants the data to be reported: for example, by yearly, quarterly, or monthly expense amounts 1411, by subsidiary 1412, by location 1413, by country 1414, by language 1415, by country of residence 1416, by country of citizenship 1417, by title of the person receiving the grant 1418, by user codes 1419, 1420, 1421, by officer of the entity providing equity-based compensation 1422, by participant ID 1423, low option price 1424 or high option price 1425. After entering in filter information, the user can enter a new report name 1426 for the report or check the box 1427 if the report name to be used is the official report system name. The user may select to be notified by the system via e-mail when the report is complete by checking box 1429. The user then clicks on the submit link 1428 to send a report request to data store 225, which processes data contained in data store 225 and performs calculations necessary to generate the requested report in response to a report request.

To access the completed report, the user clicks on link 505 of FIG. 5, which corresponds to the finished reports function. To check the status of the report, the user can click link 504, which corresponds to the report queue function. Once a report is completed, it can be exported into different formats, including for example, Excel or pdf formats. Completed reports also can be published to other team members via electronic mail, for example, or deleted.

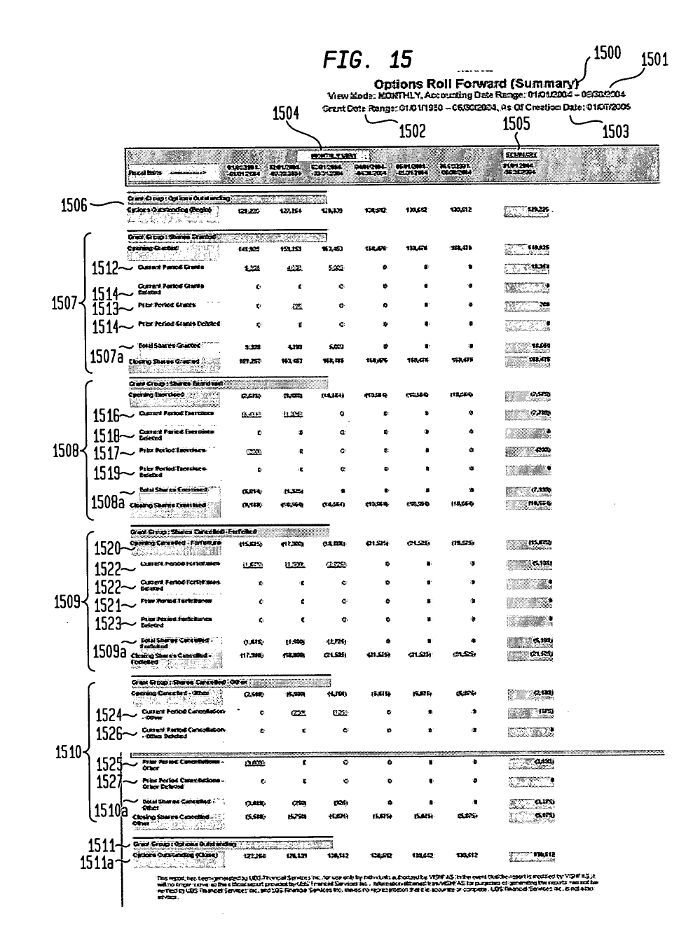

The Option Roll Forward Report 1301 contains information that shows what transactions contributed to the changes between what was reported for outstanding grants of equity-based compensation (e.g., options) from one point in time to another. An example of an Option Roll Forward Report is depicted in FIG. 15.

As shown in FIG. 15, the Option Roll Forward Report 1500 contains a view mode 1501, which can be a monthly view as shown in FIG. 15, or some other period. Report 1500 can include an accounting date range 1501, a grant date range 1502, and an as of creation date 1503. The report 1500 is presented in a monthly view 1504, but using filters it also could be presented in view of a different period, such as quarterly, annually, or a view in which all grants were presented, for example. There is also a summary column for the accounting date range 1505. The report 1500 contains information broken down by corresponding monthly view 1504 and summarized for the accounting date range 1505 of Options Outstanding (Begin) 1506, Shares Granted 1507, Shares Exercised 1508, and Shares Cancelled—Forfeited 1509, and Shares Cancelled—Other 1510, Options Outstanding (Close) 1511. Each of these categories of information can be broken down into sub-categories current period transactions, current period transactions deleted, prior period transactions and prior period transactions deleted for analysis. All of these sub-categories are capable of being reported down to the individual transaction level. Calculations are as follows:

Total Shares Granted 1507a=Grants Issued (Current Period) 1512+Grants Issued (Prior Period) 1513−Grants Deleted (Current Period) 1514−Grants Deleted (Prior Period) 1515

Total Shares Exercised 1508a=Exercises (Current Period) 1516+Exercises (Prior Period) 1517−Exercises Deleted (Current Period) 1518−Exercises Deleted (Prior Period)

Total Shares Cancelled−Forfeited 1509a=Cancellations Forfeitures (Current Period) 1520+Cancellations Forfeitures (Prior Period) 1521−Cancellations Forfeitures Deleted (Current Period) 1522−Cancellations Forfeitures Deleted (Prior Period) 1523

Total Shares Cancelled−Other 1510a=Cancellations Other (Current Period) 1524+Cancellations Other (Prior Period) 1525−Cancellations Other Deleted (Current Period) 1526−Cancellations Other Deleted (Prior Period) 1527

Options Outstanding (Closing) 1511a=Options Outstanding (Begin) 1506+Total Shares Granted 1507a−Total Shares Exercised 1508a−[Total Shares Cancelled−Forfeited 1509a+Total Shares Cancelled−Other 1510a

Because data store 225 stores each grant individually, a user can drill down the details of each individual transaction that contributed to the totals for the following data fields: Grants Issued (Current Period), Grants Issued (Prior Period), Grants Deleted (Current Period), Grants Deleted (Prior Period), Exercises (Current Period), Exercises (Prior Period), Exercises Deleted (Current Period), Exercises Deleted (Prior Period), Cancellations (Current Period), Cancellations (Prior Period), Cancellations Deleted (Current Period), Cancellations Deleted (Prior Period).

The Options Outstanding Report 1302 provides an overview of option activity as of a specific accounting or transaction date for each plan by grant date, grant type and grant price. The report includes: grant date, option price, options granted, exercised, cancelled, outstanding, outstanding weighted remaining contractual life and exercisable, in addition to aggregate outstanding option price.

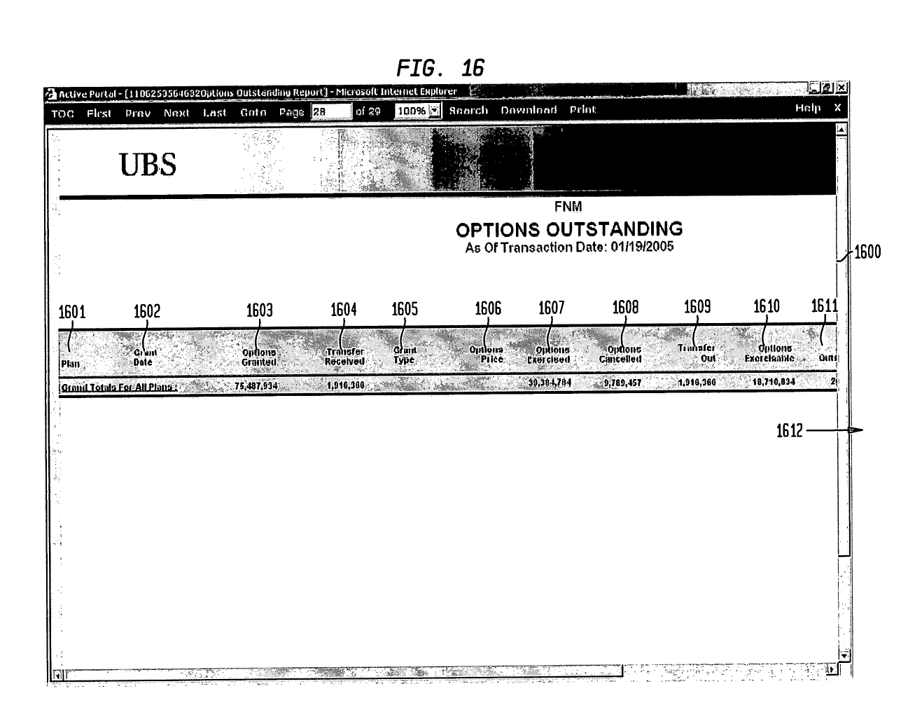

An example of an Options Outstanding Report is depicted in FIG. 16. Options Outstanding Report 1600 contains the following information:

Plan 1601: Displaying one, multiple or all plan names by plan name and ID

Grant Date 1602: The dates on which the grants were granted

Options Granted 1603: The sum of all options granted for all grants with the same plan, grant date, grant type and grant price. Grants with no options outstanding are included. They are included in the granted total, but are not a part of the weighted average calculation because they have no options outstanding.

Transfers Received 1604: The number of grants a transferor receives. A cancellation due to a transfer is not a real cancellation and does not affect the number of options outstanding for a grant. Also a transfer received is not counted in the granted amount when calculating the number of options outstanding. For convenience, transfers received and given can be segregated in a separate grouping. Exercises and cancellations not due to transfer are counted when calculating options outstanding for a grant.

Grant Type 1605: The type of grant granted to the recipient of equity-based compensation options.

Option Price Per Share 1606: The number of shares granted/Option Price

Options Exercised 1607: The sum of all options exercised, for each group of options granted, with the same plan, grant date, grant type and grant price.

Options Cancelled 1608: The sum of all options cancelled, for each group of options granted, with the same plan, grant date, grant type and grant price.

Transferred Out 1609: The number of grants transferred from transferor to transferee. Although options transferred do receive a grant ID, they are not treated as a new granted amount when calculating shares granted and terms are not included in shares outstanding calculations.

Options Outstanding 1610: Options Granted 1603−Options Cancelled 1608−Options Exercised 1607−Transfers. Transferred in and transferred out options are not included.

Options Exercisable 1610: The amount of options that can be exercised by the optionee at any given point in time. For example, if an optionee is given a grant that vests 25 percent per year over four years, the optionee will not be able to exercise any of these grants until one year from grant date. During that time period (grant date to first vest date), the optionee will have zero options exercisable, but the entire granted amount will be outstanding. At the end of each year, 25 percent of the amount granted will become exercisable. Therefore, the exercisable value will be increased after each year's vesting. Once options become exercisable, they remain so until they are either exercised or cancelled. Moreover, the exercisable options are reduced by the number of options exercised or cancelled.

Aggregate Options Outstanding Price 1611: The sum of all options outstanding multiplied by the grant/option price for each group of options with the same plan, grant date, grant type and grant price for each line item.

Options Outstanding Weighted Remaining Contractual Life 1612: The average number of contractual years remaining for the grants included in the line item. The remaining contractual life of a grant is the number of days a grant has from the end of the reporting date (as of accounting or transaction date entered in the report filters) to their expiration date. The current expiration date is used.

The Options Expense Report 1303 is the compensation and amortization report. Amortization refers to the process of defining and calculating the schedule of expense recognition (attribution) for each applicable award. FASB guidance on determining the time period for amortization can be found in paragraphs No. 196 through No. 203 (Statement of Financial Accounting Standards No. 123). The compensation expense is to be recognized over the period(s) in which the employee performs the “related services” for the award. If the service period is not defined, the compensation expense will be recognized over the vesting life of the award. Furthermore, FAS 123 directs that “the cumulative compensation cost recognized at any date must at least equal the value of the portion of the award that is vested” It calculates and displays compensation expense associated with stock option awards over the life of the awards.

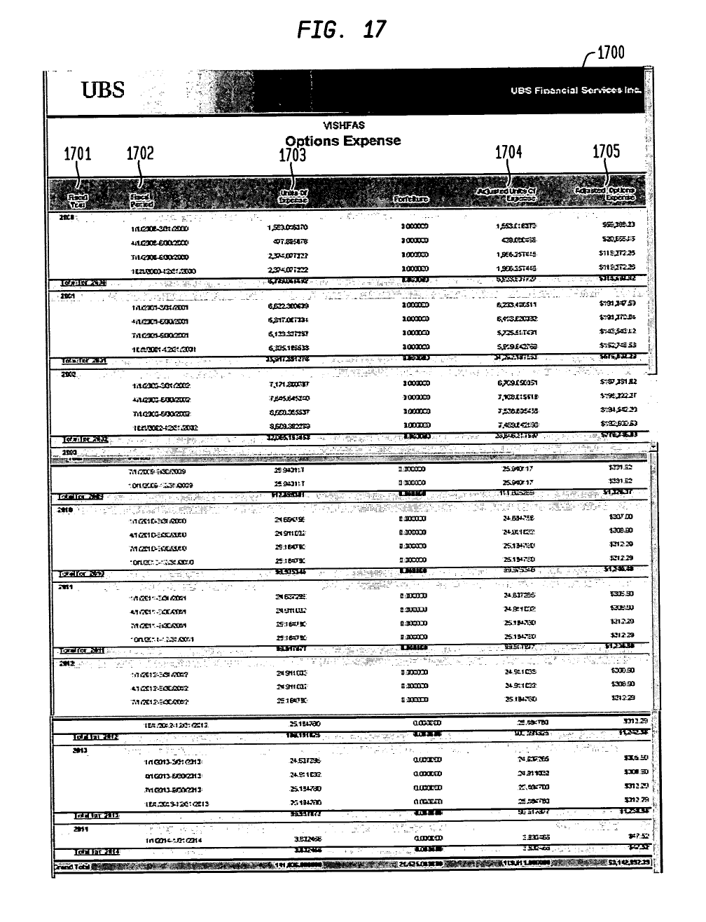

An example of an Options Expense Report is depicted in FIG. 17. As shown in FIG. 17, Options Expense Report 1700 includes the following information:

Fiscal Year 1701: The fiscal years which the reports cover

Fiscal Periods 1702: Breakdowns for the fiscal periods within each fiscal year. The periods displayed can included months, quarters, or years, depending on the selection chosen for the display expense filter by the user.

Units of Expense 1703: Original shares granted or amortized. These are the original shares amortized when the grant was originally loaded to the system and first valued. To preserve this amortization schedule, the period in which the grant was issued must be locked, otherwise when changes are made that affect the grant's expense, the original amortization schedule will be over written.

Adjusted Units of Expense 1704: This refers to the amortization schedule in units for the grant as stored by the database with an effective date range that includes the end accounting date of the report. This calculation depends on the forfeiture method used.

Actual Method: This is the method in which the amortization schedule in units for the grant is stored by the database 225 with an effective date range that includes the end accounting date of the report. All amortization schedules are adjusted and stored with a start and end effective dates when an event occurs that causes a schedule to be recalculated, e.g., a forfeiture, change in option value, change in shares granted or a deletion of a grant, cancel, etc. In a single row, original expensed minus forfeitures will not equal adjusted units expensed. A credit for a forfeiture will not be equal to the total number of units forfeited as you only receive a credit for the portion of the units expensed historically and a forfeiture relates to unvested units so they cannot be fully expensed when forfeited. At the grand total level, original expensed options minus option forfeitures will equal adjusted units expensed.

Grant Level Turnover Percentage: Similar to the actual method, for the grant level turnover percentage (estimated forfeitures) method, the amortization schedule in units for the option grant is stored by the database with an effective data range that includes the end accounting date of the report. All amortization schedules are adjusted and stored with a start and end effective dates when an event occurs that causes an estimated grant level schedule to be recalculated, e.g., a change in turnover percentage, change in option value, change in shares granted or a deletion of a grant, etc. In a single row, original expensed minus forfeitures may not equal adjusted units expensed. A credit/debit for a change in turnover % may have made. At the grand total level, original expensed minus forfeitures will equal adjusted units expensed.

User-Defined Method: For this method, units of expense less forfeitures will equal adjusted units of expense.

Adjusted Options Expense 1705: For the actual method or grant level turnover percentage forfeiture method, these values are retrieved for each grant and totaled. For the user-defined method, the Adjusted Options Expense 1705 is equal to the original expense, (original expense multiplied by forfeiture percentage entered).

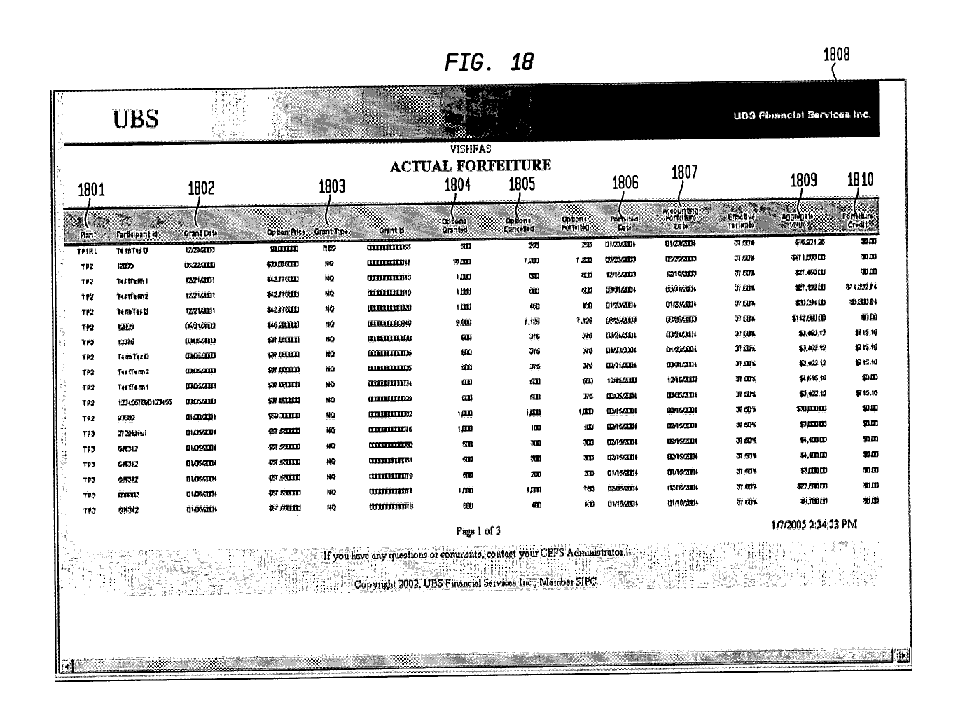

The Actual Forfeiture Report 1304 provides information on the number of options forfeited, as well as any credit created by the forfeiture, plus the aggregate value of the forfeited options (i.e., option value multiplied by the number forfeited). An example of an Actual Forfeiture Report is depicted in FIG. 18

As shown in FIG. 18, Actual Forfeiture Report 1800 includes the following information: Plan 1801, Grant Date 1802, Option Price 1803, Grant ID (the identification number assigned to each individual grant), Options Granted 1804, Options Canceled 1805, Options Forfeited 1806, Forfeited Date 1807, Accounting Forfeited Date 1808, Aggregate Value 1809 (of the forfeited options), and Forfeiture Credit 1810 (a sum of the amount expensed historically for the forfeited options).

FASB requires companies to disclose specific information about equity compensation plans. To assist clients with these disclosure requirements the report is divided into two section are referred to as “top” and “bottom.”

The top section determines the number, weighted-average exercise price and weighted average option value and intrinsic value of grants for the following; options outstanding (beginning and end of period), granted, exercised, forfeited (cancelled unvested options), and cancelled (cancelled vested) during the period and those outstanding and exercisable at the end of the period.

The bottom section determines for both outstanding and exercisable shares, the weighted average remaining contractual life (as of report date to date of expiration of option) and weighted average exercise price for each specified price range.

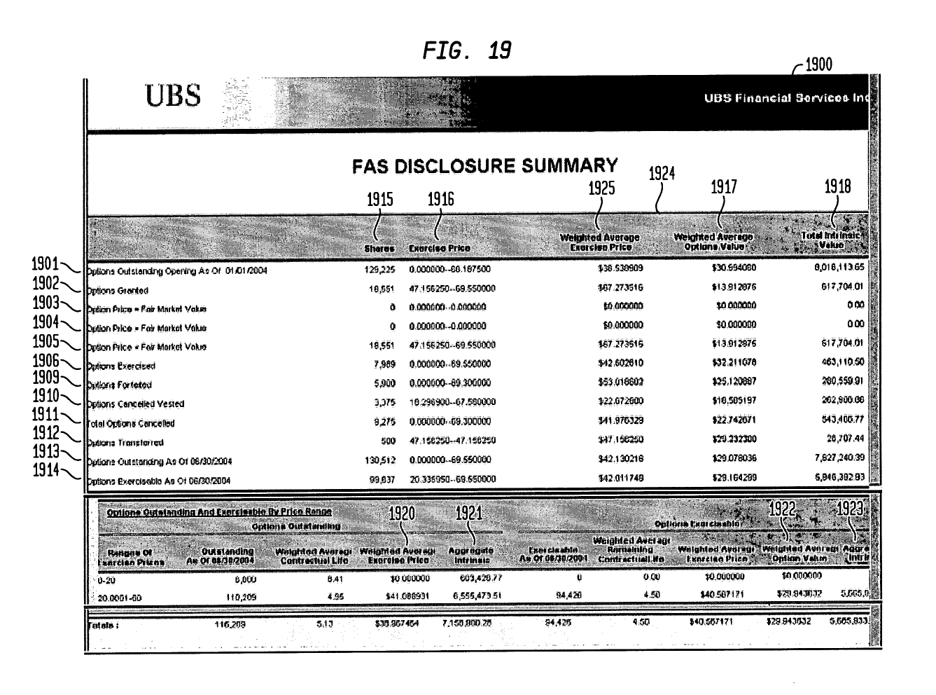

An example of an FAS Disclosure Summary report 1900 is depicted in FIG. 19. As shown in FIG. 19, Top Section 1924 contains the following information:

Options Outstanding (as of Start Accounting Date) 1901: This is the number of options outstanding as of the Start Accounting Date (all granted exercised, and cancelled option grants that occurred as of the Start Accounting Date entered for the report).

Options Outstanding (as of Start Accounting Date) 1901=Options Granted−Option Exercised−Options Cancelled Vested−Options Forfeited (cancelled unvested).

The Options Outstanding is calculated as of the end of the prior day. All transactions with an accounting date before the Start Accounting Date are included in the calculation. Grants created for options transferred are not considered as new grants and are reported in a separate group titled “Options Transferred.”

Options Granted 1902: All grants with an accounting date greater than or equal to the Start Accounting Date and less than or equal to the end accounting date are included in this line item. This does not include transfer grants. The options granted are separated in three groups 1903, 1904, 1905, where the option price is equal to, greater than, or less than the FASB FMV.

Options Exercised 1906: All options exercised with an accounting date greater than or equal to the Start Accounting Date and less than or equal to the End Accounting Date are included.

Options Forfeited 1909: The number of options cancelled as unvested with an accounting date greater than or equal to the Start Accounting Date and less than or equal to the End Accounting Date are included.

Options Cancelled Vested 1910: The number of options cancelled as vested with an accounting date greater than or equal to the Start Accounting Date and less than or equal to the End Accounting Date are included.

Total Options Cancelled 1911: All cancellations (vested and forfeited) with an account date greater than or equal to the Start Accounting Date and less than or equal to the end Accounting Date are included. Total Options Cancelled 1911=Option Forfeited 1909+Option Cancelled Vested 1910.

Options Transferred 1912: All transfers with an accounting date greater than or equal to the Start Accounting Date and less than or equal to the End Accounting Date are included.

Options Outstanding (as of End Accounting Date) 1913: Calculated based on an accounting date of the transactions. All transactions with an accounting date less than or

Options Granted 1902: All grants with an accounting date greater than or equal to the Start Accounting Date and less than or equal to the end accounting date are included in this line item. This does not include transfer grants. The options granted are separated into three groups 1903, 1904, 1905, where the option price is equal to, greater than, or less than the FASB FMV.

Options Exercised 1906: All options exercised with an accounting date greater than or equal to the Start Accounting Date and less than or equal to the end accounting date are included.

Options Forfeited 1909: The number of options cancelled as unvested with an accounting date later than or the same as the Start Accounting Date and earlier or the same as the End Accounting Date.

Options Cancelled Vested 1910: The number of options cancelled as vested with an Accounting Date later than or the same as the Start Accounting Date and earlier than the same as the End Accounting Date.

Total Options Cancelled 1911: All cancellations (vested and forfeited) with an accounting date greater than or equal to the Start Accounting Date and less than or equal to the end Accounting Date are included. Total Options Cancelled 1911=Options Forfeited 1909+Options Cancelled Vested 1910.

Options Transferred 1912: All transfers with an accounting date greater than or equal to the Start Accounting Date and less than or equal to the end accounting date are included.

Options Outstanding (as of End Accounting Date) 1913: Calculated based on an accounting date of the transactions. All transactions with an accounting date less than or equal to the End Accounting Date are included in the calculation. Options Outstanding (as of End Accounting Date) 1913=Options Granted 1902−Options Exercised 1906−Total Options Cancelled 1911.

Options Exercisable (as of End Accounting Date) 1914: The number of options exercisable as of the End Accounting Date.

For each of the above line items, data store 225 calculates the following five values:

Shares 1915: Total of all options used in the calculation.

Exercise Price 1916: The lowest and the highest exercise price of all grants included in the calculation of Options Outstanding as of Start Accounting Date.

Weighted Average Exercise Price 1925: Σ(Options Outstanding Per Grant×Exercise Price)/(Options Outstanding As of Start Accounting Date)

Weighted Average Option Value 1917: Σ(Options Outstanding Per Grant×Option Value)/(Options Outstanding As of Start Accounting Date).

Total Intrinsic Value 1918: Σ(Options Outstanding Per Grant×(Average Market Value for the period−Exercise Price)).

The bottom section 1923 of the report 1900 takes the Options Outstanding 1913 and the Options Exercisable 1914 values as of the End Accounting Date, which were calculated in top section of the report, and subsets them by exercise price ranges entered by the user.

For each price range, each grant with Options Outstanding 1913 and/or Options Exercisable 1914 is evaluated, and it is placed in the Exercise Price Range based on its exercise price, i.e., option price. The Weighted Average Remaining Contractual Life 1919 is calculated for both the Options Outstanding and Options Exercisable. Remaining Contractual Life is the amount of time, calculated in years, from the Accounting End Date to the expiration date of the grant. The Weighted Average Exercise Price 1920 is calculated for both Options Outstanding and Options Exercisable. The Aggregate Intrinsic Value 1921 is calculated for both Options Outstanding and Options Exercisable. The Weighted Average Option Value 1922 is calculated for Options Exercisable.

The Assumption Detail and Averages Report 1306 provides the following for each individual grant, or if a multiple valuation method is applied to a grant or grants, then the following will be displayed for each tranche in the grant(s):

Six assumptions: exercise price, FMV, expected life of the option, expected volatility, expected dividends on the stock and the risk-free interest rate for the expected term of the option (only required for NQs and ISOs)

Turnover Percentage: This will only be displayed if a Grant Level Turnover Percentage is selected as a forfeiture method in Company Settings

Option Pricing Models: Black-Scholes, Binomial, Other

Option Value

Start and end dates for each set of assumptions, if multiple option valuation is selected

Total Grant Value (Options Granted×Option Value)

Weighted averages for exercise (Grant Price) Price, expected life, expected volatility, expected dividends, risk-free interest rate and option value

At the end, the report totals options granted and total grant value.

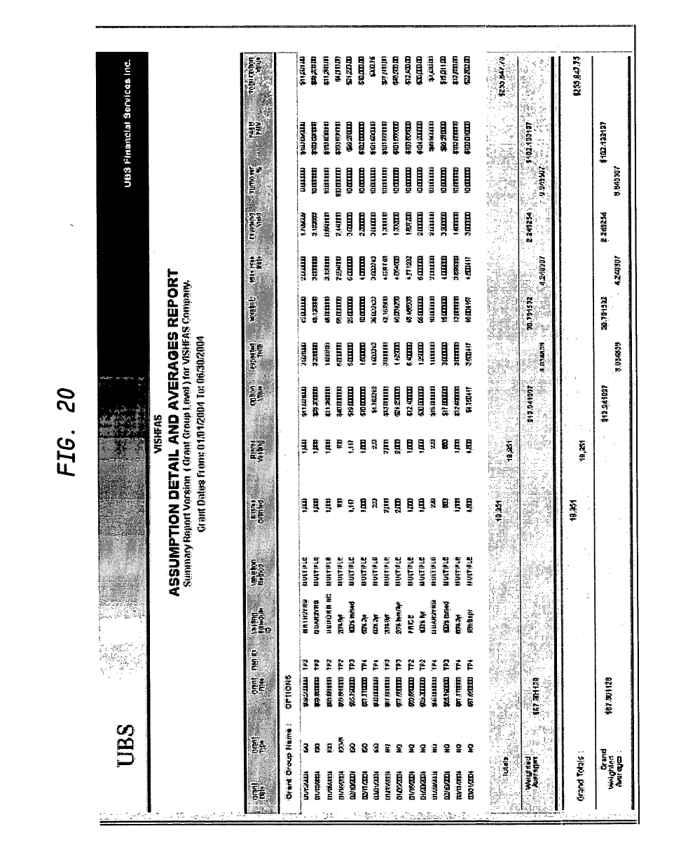

An example of an Assumption Detail and Averages Report is depicted in FIG. 20. The report retrieves the grants using the following filter selections: (1) assumptions, (2) turnover percentage, if available, (3) option value, (4) grant date, (5) grant ID, (6) options granted, (7) grant type, (8) total option value and (9) any other grant detail selected as part of the report criteria.

The EPS Report 1307. Companies are currently required to disclose two computations of earnings per share in annual financial statements: basic EPS (Earnings per Share) and diluted EPS. Basic EPS is simply income available to common stockholders for the fiscal year (the numerator) divided by the weighted average number of common shares outstanding (the denominator) during the fiscal year. Diluted EPS goes one step further to determine the earnings per share if all dilutive potential common shares were actually converted into common stock outstanding for the entire year. The goal of EPS Report 1307 is to calculate dilutive effect for Weighted Options Outstanding, Exercises, and Cancellations that occurred during the reporting period.

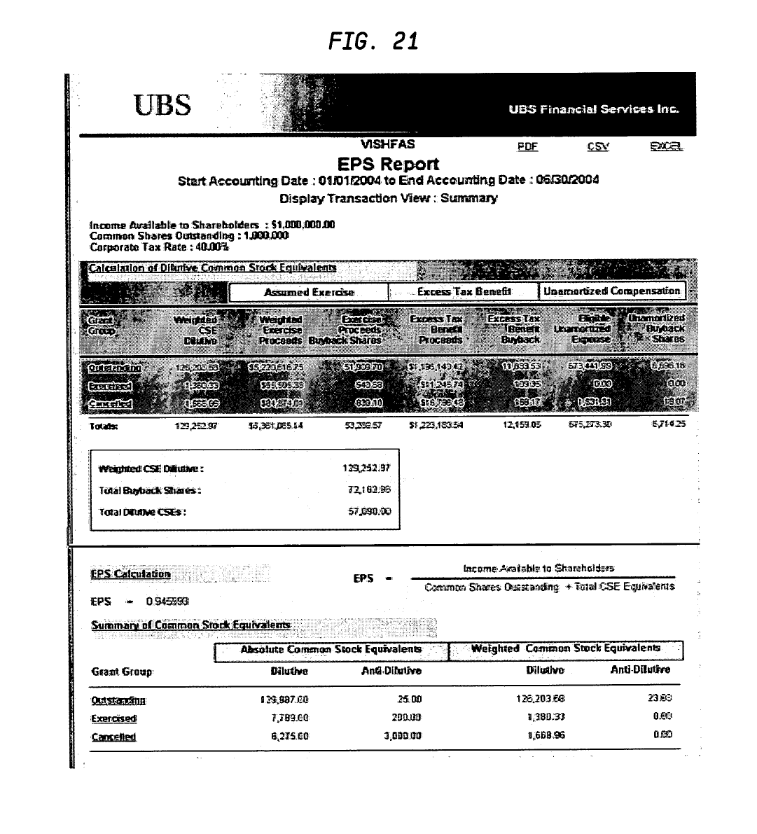

An example of an EPS Report is depicted in FIG. 21. All EPS calculations are delivered in four reports:

Dilutive and Anti-Dilutive Weighted Options Outstanding at the end of the reporting period (includes grant level detail)

Dilutive and Anti-Dilutive Weighted Exercises that occurred during the reporting period for the grants included in the report

Dilutive and Anti-Dilutive Weighted Cancelled that occurred during the reporting period for the grants included in the report

Dilution Effect Summary—a single page which summarizes the above dilutive and anti-dilutive transactions and performs the EPS calculation.

Deferred Tax Asset Reporting (of qualified stock options): Generally, qualified stock options given to executives and employees, which comply with certain requirements of the Internal Revenue Service. The employee or executive who receives a qualified stock option is not required to pay taxes on the option at the grant date or the date when the option is exercised. For qualified stock options, the tax consequences of the option for the option holder can be deferred until the shares purchased under the option are actually sold.

Companies must determine the tax deduction to which they are entitled for qualified stock options. Generally, a company is entitled to a tax deduction at any time the employee granted the option recognizes compensation income. If the employee receiving the option recognizes compensation income, then the company granting the option is entitled to a similar tax deduction.

FASB standards presently require companies to record a deferred tax asset for qualified stock options that is calculated based on the book expense of the option grant and then compare the actual tax benefit realized by the employee to the previously recorded deferred tax asset for those options. If the actual tax benefit exceeds the previously recorded deferred tax asset, then the excess amount is treated as paid in capital. If it is less than the previously recorded deferred tax asset, the shortfall is generally treated as an additional tax expense. Thus, to be able to provide Deferred Tax Asset Reporting, a system must be able to calculate the actual booked and potential deferred tax asset value for an option grant and then compare them to the tax benefit upon exercise. This is difficult to do when the deferred tax asset has not been booked for the entire life of the option grant and the company starts expensing the option on the grant date.

To be capable of producing Deferred Tax Asset Reporting, data store 225 also contains information regarding the adoption date, which is the date the company starts expensing qualified stock options in accordance with FASB standards. Data store 225 calculates on a per tranche (i.e., group of options granted on the same date) per grant level the percentage of the tranche that has been expensed up to the adoption date.

The above described embodiments of the invention are intended to be illustrative only. Those having ordinary skill may be able to devise numerous alternative embodiments without departing from the spirit and scope of the invention.

What is claimed is:

1. A method for analyzing and reporting equity-based compensation comprising the steps of:
storing in a computer data store information regarding a financial calendar for an entity providing equity-based compensation;
storing information in the data store regarding how the entity determines how grants of equity-based compensation are awarded, vested, and/or forfeited in the data store;
storing information in the data store regarding methods that the entity uses to account for equity-based compensation in the data store;
storing transaction information in the data store regarding the entity's grants of equity-based compensation;
communicating a request to the data store via a client device to use the information stored in the data store to produce financial accounting reports for the entity's grants of equity-based compensation; and
receiving requested financial accounting reports produced from the information stored in the data store.

2. The method of claim 1, wherein the information regarding the financial calendar for the entity providing equity-based compensation includes information regarding whether any fiscal reporting periods should be locked.

3. The method of claim 1, wherein the information regarding the methods that the entity uses to account for equity-based compensation includes information regarding methods that the entity uses to determine fair market value of equity-based compensation grants.

4. The method of claim 1, wherein the transaction information is stored by individual grant and the data store can access transaction information by individual grant.

5. The method of claim 4, wherein the transaction information includes grant type and grant identification information.

6. The method of claim 1, wherein at least some portion of the transaction information is extracted from a separate data store for a system for administering equity-based compensation using a data extract tool.

7. The method of claim 1, wherein the information regarding methods that the entity uses to account for equity-based compensation includes option pricing model information.

8. The method of claim 1, wherein the request to the data store via a client device to produce financial accounting reports includes filters for including information in or excluding information from the financial accounting reports.

9. The method of claim 1, wherein the financial accounting reports received are comply with FASB accounting standards without the need for additional data processing.

10. The method of claim 1, wherein the financial accounting reports include at least one of an Option Roll Forward Report, Options Outstanding Report, Options Expense Report, Actual Forfeiture Report, FAS Disclosure Summary Report, Assumption Detail and Averages Report, Earnings Per Share Report, and Deferred Tax Asset Reports.

11. The method of claim 4, wherein the transaction information includes information regarding exercised options, canceled options, forfeited options, and option prices.

12. The method of claim 4, wherein the transaction information includes transaction dates.

13. The method of claim 4, additionally comprising storing in the data store creation dates and accounting dates for each of the grants of equity-based compensation.

14. A system for analyzing and reporting equity-based compensation comprising:
at least one server computer connected to a computer connected over a communication network to at least one client device, the at least one server computer including application programming;
a data store for analyzing and reporting equity-based compensation, the system being operative for:
receiving identification information from a user;
determining the user's entitlement to available features of the system based on the identification information;
sending and receiving requests to the data store via a client device to produce financial accounting reports for the entity's grants of equity-based compensation; and
producing the financial accounting reports from the data store in response to the requests; and
sending the financial accounting reports to the user, wherein the data store is programmed to store and process information including:
information regarding a financial calendar for an entity providing equity-based compensation;
information regarding how the entity determines how grants of equity-based compensation are awarded, vested, and/or forfeited in the data store;
information regarding methods that the entity uses to account for equity-based compensation in the data store; and
transaction information regarding the entity's grants of equity-based compensation.

15. The system of claim 14, wherein the information regarding the financial calendar for the entity providing equity-based compensation includes information regarding whether any fiscal reporting periods should be locked.

16. The system of claim 14, wherein the information regarding the methods that the entity uses to account for equity-based compensation includes information regarding methods that the entity uses to determine fair market value of equity-based compensation grants.

17. The system of claim 14, wherein the information regarding the methods that the entity uses to account for equity-based compensation includes information regarding methods that the entity uses to determine fair market value of equity-based compensation grants.

18. The system of claim 14, wherein the data store is programmed to store and process the transaction information by individual grant and the data store can access transaction information by individual grant.

19. The system of claim 17, wherein the transaction information includes grant type and grant identification information.

20. The system of claim 14, additionally comprising a data extract tool connected to the data store and a second data store for a system for administering equity-based compensation.

21. The system of claim 14, wherein the information regarding methods that the entity uses to account for equity-based compensation includes option pricing model information.

22. The system of claim 14, wherein the data store is programmed to receive and process the requests to produce financial accounting reports that includes filters for including information in or excluding information from the financial accounting reports.

23. The system of claim 14, wherein the financial accounting reports produced comply with FASB accounting standards without the need for additional data processing.

24. The system of claim 1, wherein the financial accounting reports produced include at least one of an Option Roll Forward Report, Options Outstanding Report, Options Expense Report, Actual Forfeiture Report, FAS Disclosure Summary Report, Assumption Detail and Averages Report, and Earnings Per Share Report, and Deferred Tax Asset Reports.

25. The system of claim 17, wherein the transaction information includes information regarding exercised options, canceled options, forfeited options, and option prices.

26. The system of claim 17, wherein the transaction information includes transaction dates.

27. The system of claim 17, wherein the data store is programmed to store creation dates and accounting dates.
